(19) United States
(12) Patent Application Publication
(10) Pub. No.: US 2023/0244357 A1
(43) Pub. Date: Aug. 3, 2023

(54) GRAPHICAL EDITING OF ANIMAL FEED PRODUCT COMPOSITION

(71) Applicant: CAN TECHNOLOGIES, INC., Wayzata, MN (US)

(72) Inventor: Annette Christine LUNDEEN, Monticello, MN (US)

(73) Assignee: CAN TECHNOLOGIES, INC., Wayzata, MN (US)

(21) Appl. No.: 18/000,160

(22) PCT Filed: May 26, 2021
(86) PCT No.: PCT/US2021/034229

§ 371 Date: Nov. 29, 2022

Related U.S. Application Data
(60) Provisional application No. 63/031,817, filed on May 29, 2020.

(51) Int. Cl. G06F 3/0482; G06Q 10/0631; G06Q 50/04; G06F 3/0486

(52) U.S. Cl. CPC G06F 3/0482; G06F 3/0486; G06Q 10/06316; G06Q 50/04; G06F 2203/04803

(57) ABSTRACT

Abstract: Disclosed are embodiments for visual editing of animal feed formulations. Some embodiments display a visual hierarchy representing a structure of ingredients included in an animal feed formulation. By graphically manipulating the visual hierarchy, the animal feed formulation is edited accordingly. In some embodiments, a first ingredient can be dragged from an ingredient palette to the hierarchy, and dropped on a target node representing a second ingredient. The first ingredient is then added to a list of ingredients included in the second ingredient. In some embodiments, an ingredient can be deleted from the animal feed formulation by selecting a node in the hierarchy that represents the ingredient, and deleting the node from the hierarchy. Any child nodes of the deleted node are also deleted from the hierarchy, and the ingredients they represent also deleted from the animal feed formulation.

### CROSS-REFERENCE TO RELATED APPLICATIONS

This application claims the benefit of U.S. Provisional Pat. Application No. 63/031,817, filed May 29, 2020, and entitled “GRAPHICAL EDITING OF ANIMAL FEED PRODUCT COMPOSITION”, which is incorporated by reference herein in its entirety.

### BACKGROUND

Generating cost effective animal feeds is important both to ensure adequate animal nutrition and marketability of animal products. In one approach, management of animal feed formulation can be performed using tables, either manually or using limited automation to organize the sometimes vast amounts of data associated with different animal feed formulations. In such an approach, modification of an animal feed formulation may include manual editing of particular rows of a table that define components of a particular animal feed formulation. While this approach to animal feed formulation has proven reliable over many years, it also presents training and usability challenges, such as when new employees are introduced to the animal feed formulation process. Further, the table-driven nature of this approach can make it difficult to visualize various components of animal feed, and how the various components interrelate to each other. Therefore, improved methods of defining an animal feed formulation are needed.

### BRIEF DESCRIPTION OF FIGURES

FIG. 1 is an overview diagram of an example comprising a graphical computer user interface that is implemented in one or more of the disclosed embodiments.

FIG. 2 shows an example comprising a computer user interface for selecting a product specification for graphical editing.

FIG. 3 shows another example comprising a graphical editing window for an animal feed product.

FIG. 4 is an example computer user interface that is displaying an ingredient hierarchy of an animal feed product.

FIG. 5 is an example computer user interface that is displaying a modified version of the ingredient hierarchy of FIG. 4.

FIG. 6 is an example computer user interface that is displaying an ingredient hierarchy of an animal feed product.

FIG. 7 is an example computer user interface that displays a data table upon which the ingredient hierarchy of FIG. 6 is based.

FIG. 8 is an overview of an animal feed production system.

FIG. 9 shows an illustrative example comprising data structures that can be implemented in one or more of the disclosed embodiments.

FIG. 10 is a flowchart of an example process that can be used for graphically editing an animal feed product.

FIG. 11 is a flowchart of an example process that can be used for graphically editing an animal feed product.

FIG. 12 illustrates a block diagram of an example comprising a machine upon which any one or more of the techniques (e.g., methodologies) discussed herein may be performed.

### DETAILED DESCRIPTION

As discussed above, one approach to animal feed formulation is table driven, such as software-implemented (at least in part) and allowing users to control animal feed formulations by editing cells of a plurality of interrelated tables. The animal feed formulation industry has adopted such as table-oriented approach to animal feed formulation, with a large number of users trained to apply this table-oriented approach to animal feed formulation. However, this table-oriented approach to animal feed formulation presents a technical problem in that it may inhibit an ability to visualize a composition of an animal feed product at many levels of abstraction quickly and easily. For example, linkages between ingredients in an animal feed product are represented, in a table-driven model, by references between various tables representing each of the ingredients included in the animal feed product. Following the references can require a user to page between a number of tables, or at least scroll across multiple ingredients to follow the references between ingredients, and relationships between related constituents from different tables are not generally visually apparent.

The disclosed embodiments present a technical solution to this technical problem by providing a visual approach to the creation and editing of animal feed formulations. For example, the composition of an animal feed product is represented, in some of the disclosed embodiments, as a visual hierarchy of ingredients. A root node or object of the hierarchy represents a product specification for an animal feed product. Child nodes of the root node represent a first level of ingredients that are included in the animal feed product. A second level of the hierarchy, if present, represents a second level of ingredients that are included in the first level ingredients. In some of the disclosed embodiments, an ingredient is deleted from the animal feed product by simply highlighting a node of the hierarchy representing the agreement, and deleting the node from the hierarchy. Any child nodes of the deleted node are also deleted. An ingredient represented by the parent node is then updated to remove any ingredients represented by the deleted nodes.

In some embodiments, an ingredient is added to the animal feed product by adding a node to the hierarchy representing the ingredient. Where in the hierarchy the ingredient is added influences which component of the animal feed product includes the ingredient. For example, in some embodiments, an ingredient is dragged from an ingredient pallet and dropped on a preexisting target node in the hierarchy. The dropping of the ingredient onto the target node adds the dropped ingredient to the ingredient represented by the target node. In some embodiments, an ingredient can be added by selecting the ingredient in the ingredient palette, and using copy/paste functionality to paste the ingredient onto a preexisting target node in the hierarchy. The graphical presentation and editing of the hierarchy causes corresponding changes to the animal feed composition data that defines the animal feed formulation.

After editing of the animal feed formulation is complete, data defining the animal feed formulation is saved as a production instruction set to a data store. This production instruction set defines ingredients included in the animal feed formulation, an amount of each ingredient, and also a production order in which those ingredients are combined. The production instruction set is then provided to a manufacturing facility, where the production instruction set controls how the animal feed product is manufactured.

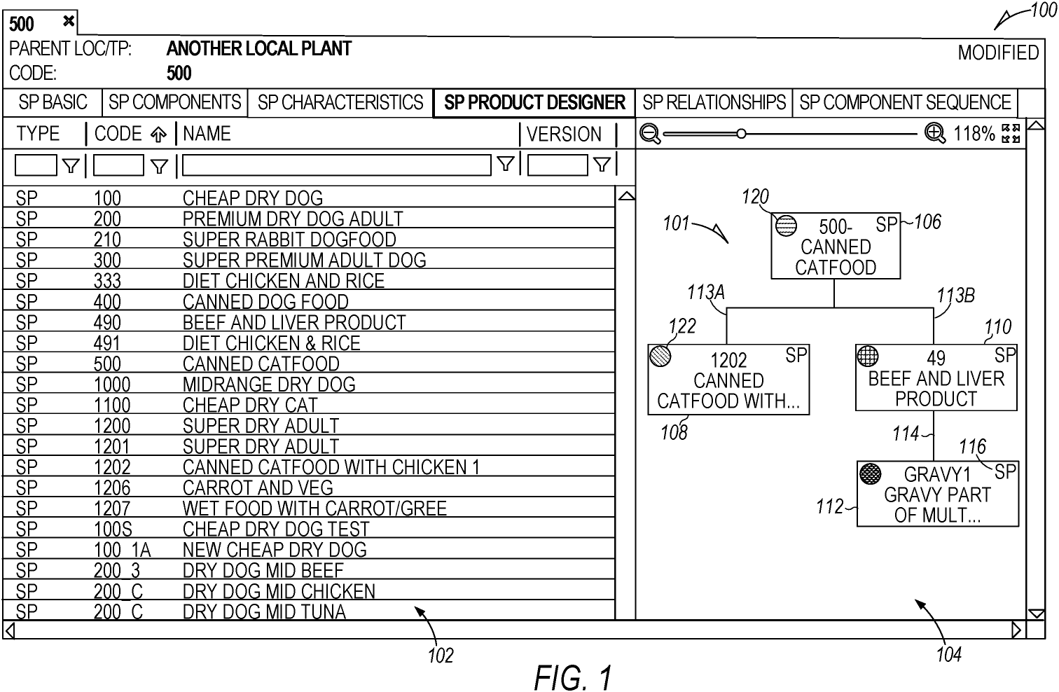

FIG. 1 is an overview diagram of one example graphical user interface that is implemented in one or more of the disclosed embodiments. The graphical user interface shown in FIG. 1 provides one approach to editing of a product specification for an animal feed product. Once the product specification is finalized via the editing process, the product specification is used to generate a product instruction set that can be sent to a production facility. Thus, the graphical user interface shown in FIG. 1 is one example of facilitating production of an animal feed product.

The graphical user interface 100 includes at least two windows. A first window 102 includes an ingredient palette or a list of ingredients. The second window 104 displays a hierarchy 101 of ingredients for an animal feed product. Included in the hierarchy 101 is a root node 106. The root node 106 has two child nodes, a first child node, the node 108 and a second child node, the node 110. The second child node, node 110 is also a parent node of a third child node, the node 112. FIG. 1 shows that parent nodes are connected to their child nodes via a graphical indicator. In the example of FIG. 1, the graphical indicator is a line, such as lines 113A and 113B, which graphically connect the root node 106 to its child nodes, node 108 and node 110, and line 114, which graphically connects node 110 to its child node, the node 112.

The hierarchy 101 of the graphical user interface 100 communicates that an ingredient represented by a parent node includes ingredients represented by child nodes of the parent node. Any ingredient represented by the hierarchy 101 can be one or more of a sub-ingredient and/or a component ingredient. Sub-ingredients are ingredients included in other ingredients. Thus, a first ingredient represented by a child node is a sub-ingredient of a second ingredient represented by the child node’s parent node. Component ingredients include other ingredients. Thus, a component ingredient represented by a parent node includes sub-ingredients represented by child nodes of the parent node. Thus, in the example of FIG. 1, the ingredient “canned cat food” represented by the parent and root node 106 is a component ingredient that includes the sub-ingredients represented by node 108 and node 110. Similarly, the ingredient represented by node 110 is also a component ingredient in that it includes the sub-ingredient represented by node 112, since node 112 is a child node of node 110.

At least some of the nodes shown in the hierarchy 101 also include stage indicators, such as stage indicators 120 and 122. The stage indicators provide a unique graphical indicator for each different stage in which an ingredient can be classified. The stage of each ingredient is configurable in some embodiments. In some embodiments, each unique graphical stage indicator is a different color. Other embodiments utilize shape or icons to represent different stages. At least some of the nodes shown in the hierarchy 101 also include a type indicator, such as type indicator 116. The type indicator includes, in some embodiments one or more characteristics indicating a particular ingredient type. Ingredient types are mutually exclusive in some embodiments, and include, in various embodiments, one or more of fixed formulas, components, ingredients, or product specifications.

Some of the disclosed embodiments provide for graphical manipulation of the hierarchy 101 so as to change ingredients of an animal feed product. The graphical manipulation can result in adding, deleting or moving nodes that represent ingredients within the hierarchy 101. One method of adding an ingredient to the hierarchy 101 includes dragging a first ingredient from the first window 102 and dropping the first ingredient onto a second node already included in the hierarchy. The second node represents a second ingredient. Dropping the first ingredient onto a second node representing a second ingredient is interpreted, in some embodiments, as a command to add the first ingredient to the second ingredient. Thus, the second ingredient, after the command is performed, is a component ingredient that includes at least the first ingredient. Beyond adding ingredients in the manner described above, an ingredient can be moved, in some embodiments, by dragging a node representing the ingredient to a different position of the hierarchy. This will cause the moved ingredient to be deleted from the component ingredient represented by its previous parent node. The moved ingredient will be added to a new ingredient represented by a parent node of the node after the move is performed.

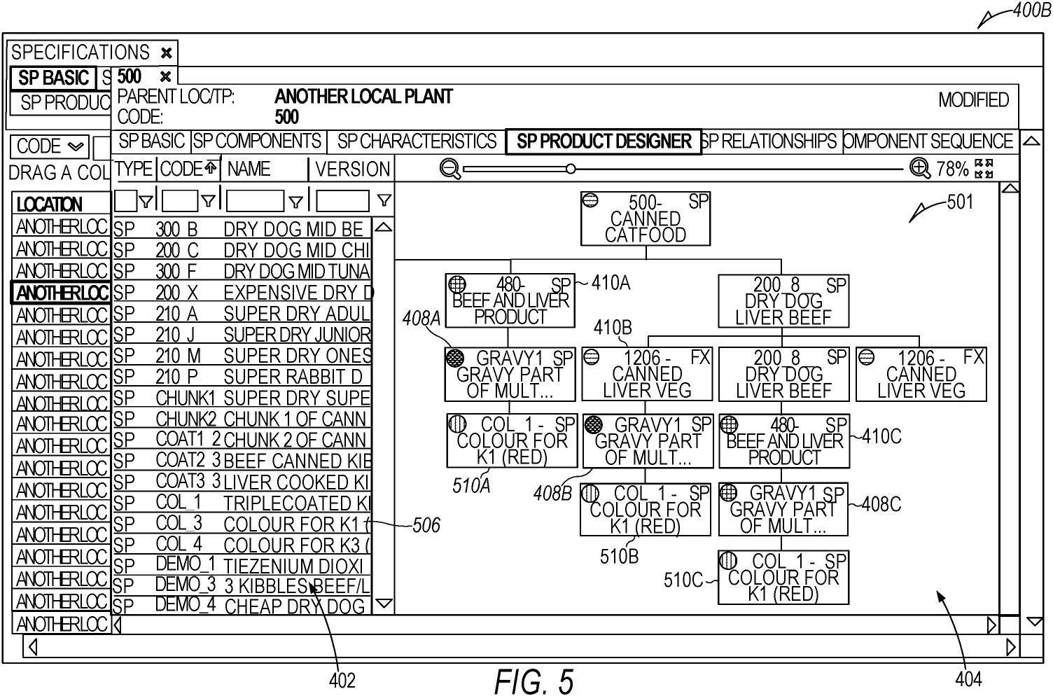

As will be discussed in more detail below, each ingredient is represented, in some embodiments, as a table or other multi-entry data structure. The data structure defines a list of ingredients or sub-ingredients included within the ingredient. When a first ingredient is dropped onto a node representing a second ingredient, the multi-entry data structure representing the second ingredient is amended to reflect the addition of the dropped first ingredient. Similarly, when an ingredient is deleted or moved away from a second ingredient, the second ingredient’s multi-entry data structure is modified to remove the deleted or moved ingredient. This is discussed in more detail below with respect to FIG. 5. Note that while the hierarchy 101 shown in FIG. 1 includes only three levels, the disclosed subject matter does not contemplate any limit on the depth of a hierarchy. Thus, the disclosed embodiments could include any number of levels.

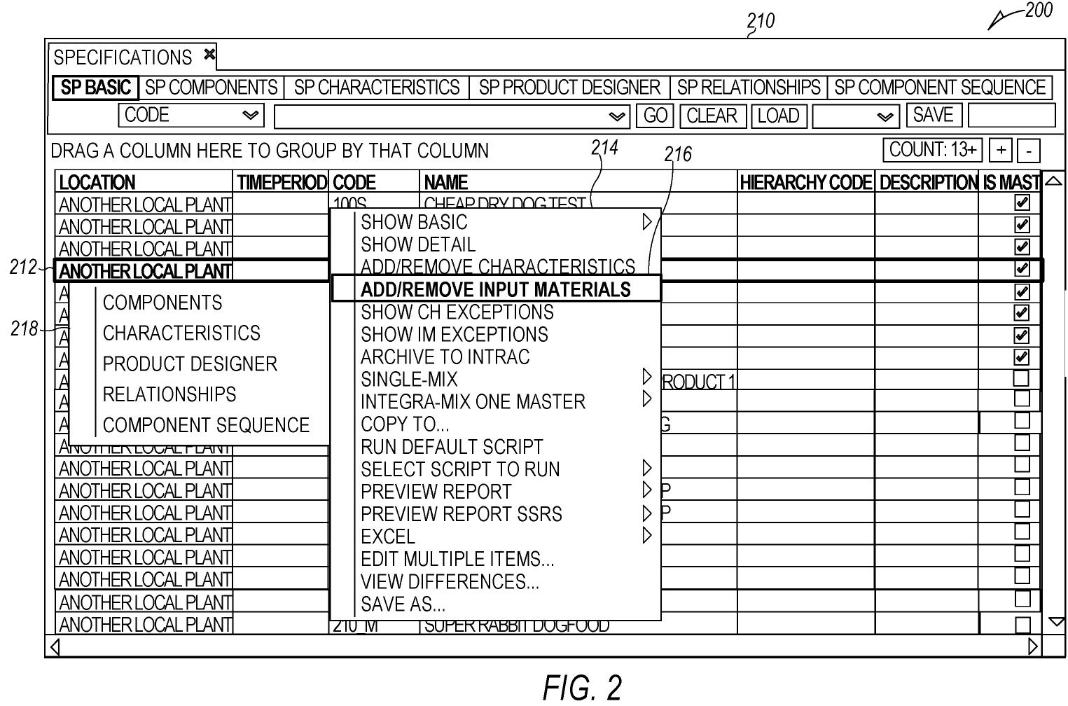

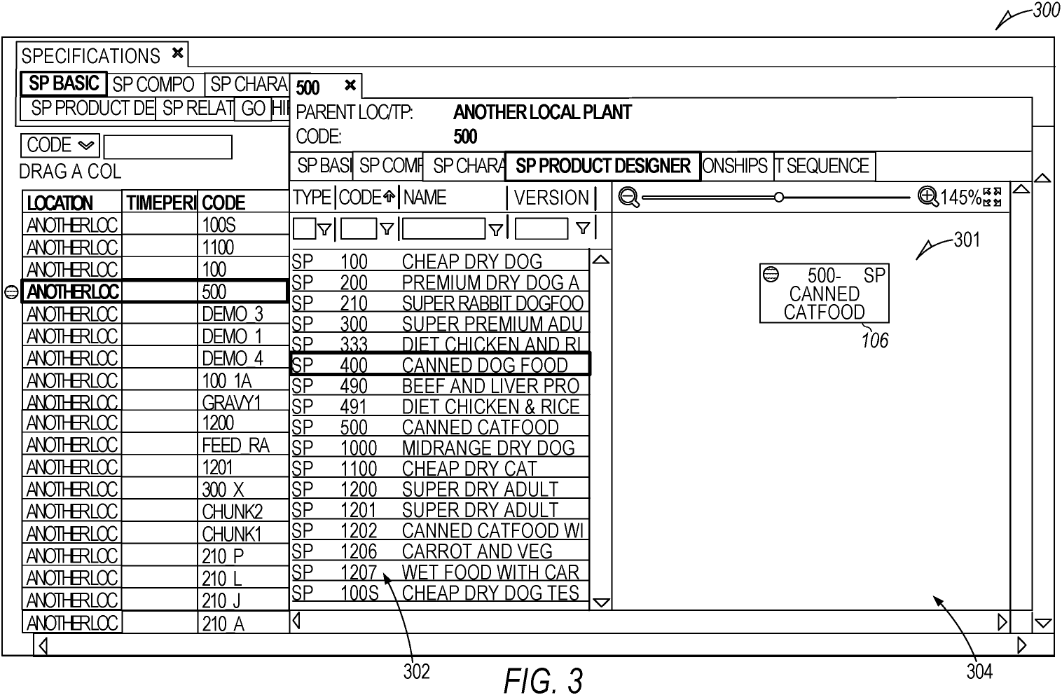

FIG. 2 shows an example user interface 200 for selecting a product specification for graphical editing. The user interface 200 shows a window 210 that provides an ingredient palette or list of ingredients. The user interface 200 shows that one of the ingredients, 212 “Canned Catfood,” which is partially obscured by the menu window 214, has been selected to display the menu window 214. A menu item 216 is selected from the menu window 214 to display a second menu window 218. One of the choices in the second menu window 218 is shown as “product designer.” In some embodiments, upon selecting the “product designer” menu item in the second menu window 218, a graphical editing window is displayed. Such a graphical editing window is shown in FIG. 3 discussed below.

FIG. 3 shows an example of an application display 300 for an animal feed product. In some embodiments, the animal feed product is a pet food product. The application display 300 includes at least two windows. A first window 302 is an ingredient palette that includes a list of ingredients. A second window is a graphical editing window 304. The graphical editing window 304 displays a root node 106 representing the canned cat food product 212 that was selected via the menus discussed above with respect to FIG. 2. The root node 106 is displayed after the canned cat food product 212 of FIG. 2 is selected, and the second menu window 218 labeled “product designer” is selected. Note that in contrast to the graphical user interface 100 discussed above with respect to FIG. 1, in the view shown in FIG. 3, the root node 106 has no children. This is a result of FIG. 3 showing a graphical user interface representing a state of the animal feed product before additional editing operations on the canned cat food product represented by FIG. 1 are performed.

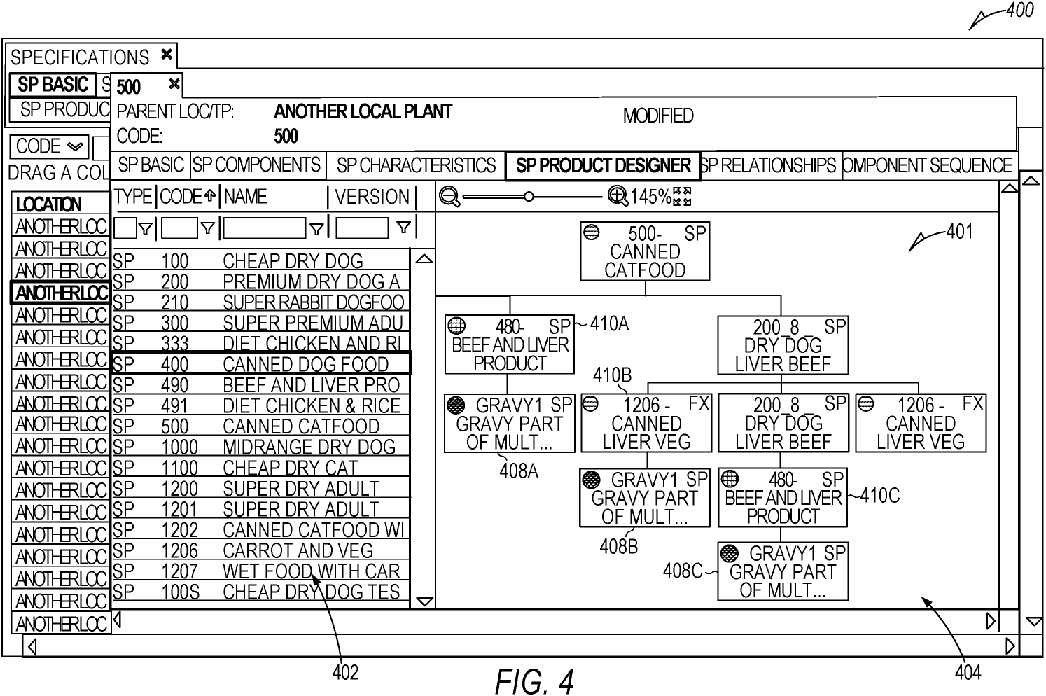

FIG. 4 is an example computer user interface that is displaying an ingredient hierarchy of an animal feed product. The computer interface 400 shown in FIG. 4 displays a first window 402 and a second graphical editing window 404. Within the second graphical editing window 404, an ingredient hierarchy 401 is displayed. The ingredient hierarchy 401 includes multiple instances of a single gravy ingredient, shown collectively as 408A-C. The gravy ingredient is common across three component ingredients 410A-C, as demonstrated by the multiple instances of the gravy ingredient.

FIG. 5 is an example computer user interface that is displaying a modified version of the ingredient hierarchy of FIG. 4. FIG. 5 shows the first window 402 and second graphical editing window 404 of the computer interface 400B. The second graphical editing window 404 shows a modified version of the ingredient hierarchy 401 from FIG. 4, as hierarchy 501. The first window 402 shows a “colour for K1 (Red)” ingredient 506. The hierarchy 501 shows a modification to the ingredient hierarchy 401 of FIG. 4 after the ingredient 506 is dragged from the first window 402 and dropped on any one of the gravy ingredients 410A-C. As shown by FIG. 5, at least some of the disclosed embodiments recognize that the gravy ingredient (represented by nodes 408A-C) has multiple instances within the ingredient hierarchy 401, since the gravy ingredient is common across several component ingredients, such as the component ingredients 410A-C. When the ingredient 506 is dropped onto any one of the gravy ingredients 408A-C, it is automatically (without any further input) added to all of the identical gravy ingredients in the hierarchy (e.g. gravy ingredients 408A-C in the example of FIGS. 4-5). The identical gravy ingredients are identical in the type of ingredient only. These ingredients may vary by amount. For example, each of the component ingredients 408A-C may include different amounts of the common gravy ingredient represented by nodes 408A-C. In this case, the disclosed embodiments still add a first ingredient (e.g. ingredient 506) to each of the second ingredients (e.g. gravy ingredients 408A-C) when receiving an input adding the first ingredient to any of the second ingredients. This is shown by nodes 510A-C, which represent the addition of the first ingredient (e.g. ingredient 506) to each of the second ingredients (e.g. gravy ingredient represented by nodes 408A-C).

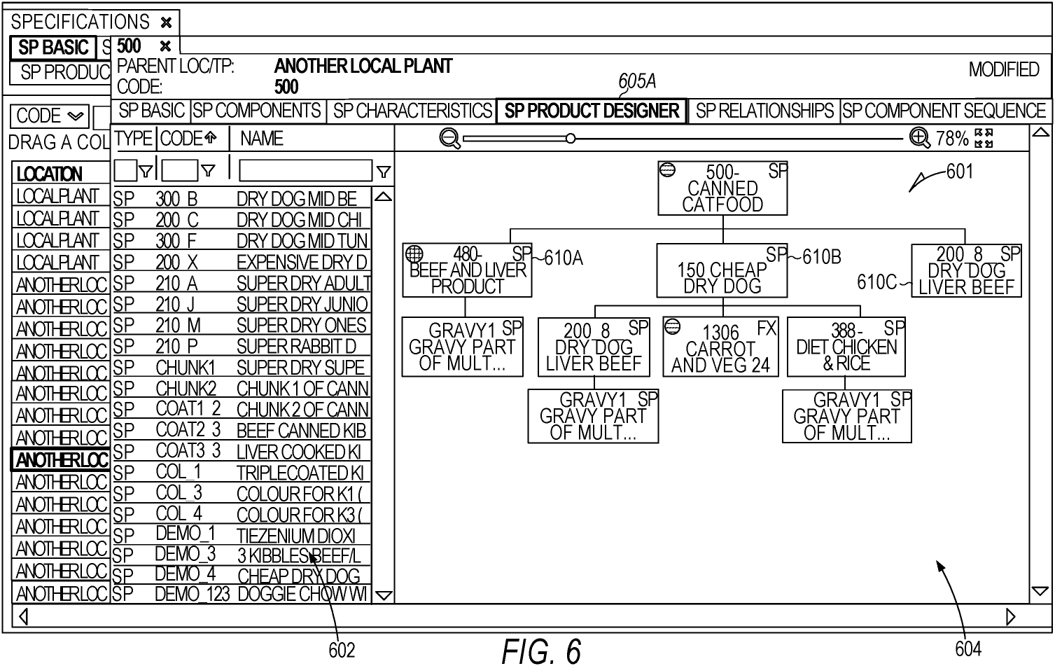

FIG. 6 is an example computer user interface that is displaying an ingredient hierarchy of an animal feed product. FIG. 6 shows a first window 602 including a list of ingredients and a second graphical editing window 604. The second graphical editing window 604 displays an ingredient hierarchy 601. The ingredient hierarchy 601 includes at least three ingredients 610A-C at a first level of the hierarchy.

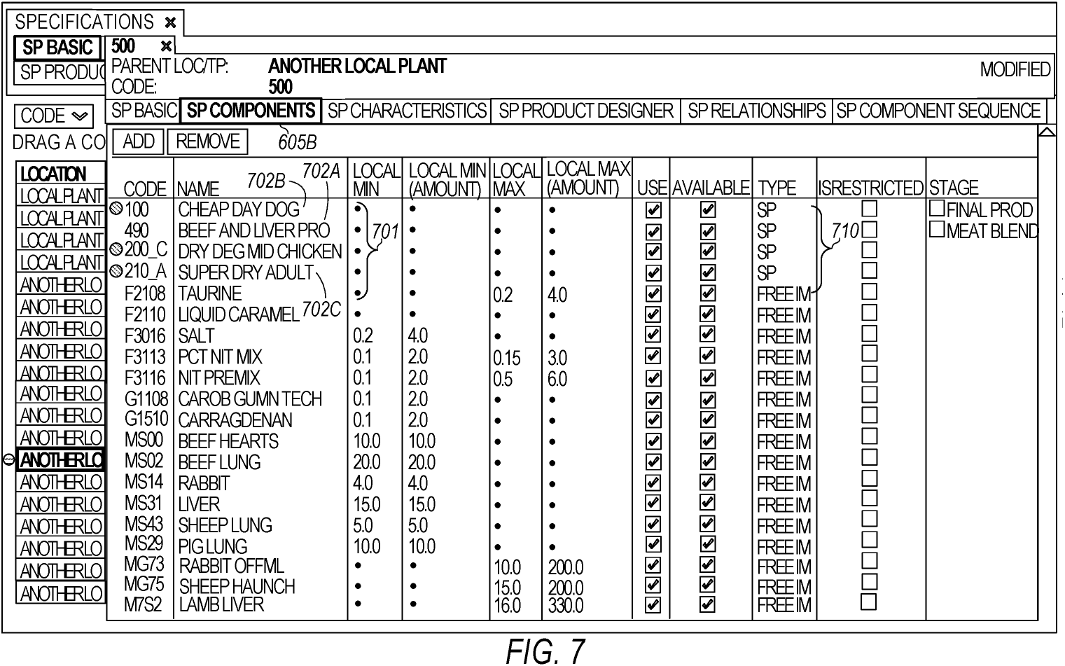

FIG. 7 is an example computer user interface that displays a data table upon which the ingredient hierarchy of FIG. 6 is based. FIG. 7 shows product specification ingredients 701. These include product specification 702A, for “beef and liver product,” which corresponds to node 610A of FIG. 6. Product specification 702B, for “CHEAP DRY DOG,” corresponds to node 610B of FIG. 6. Product specification 702C, for “SUPER DRY Adult,” corresponds to node 610C of FIG. 6. FIG. 7 illustrates that each of these ingredients are product specifications via type indicators 710.

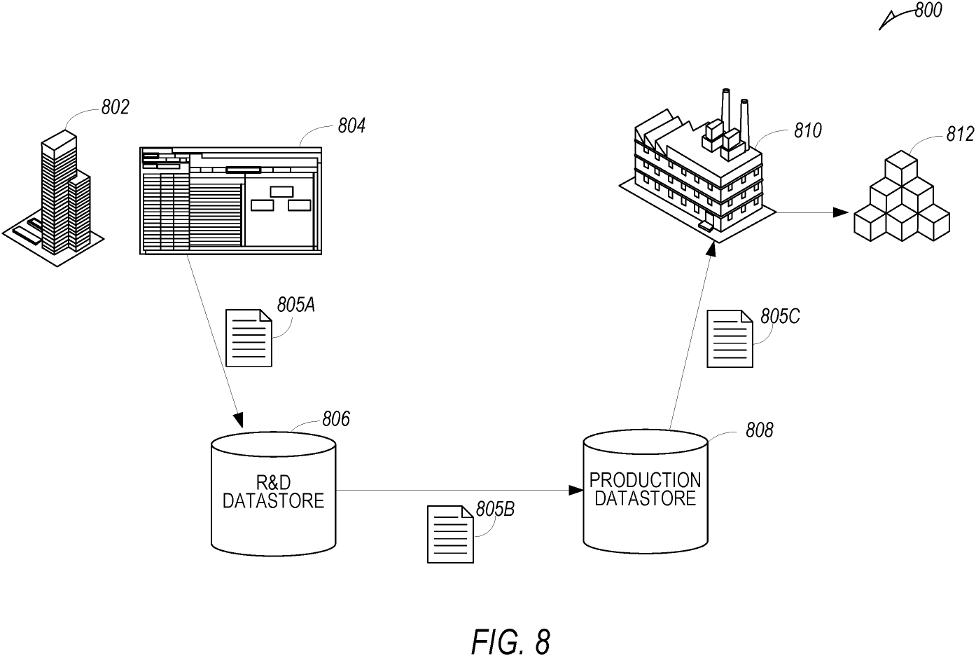

FIG. 8 is an overview of an animal feed production system. The animal feed production system 800 includes a research and development (R & D) environment 802 represented by an office building. Within the R&D environment is an animal feed definition software application includes a graphical user interface 804. The graphical user interface 804 is equivalent to the graphical user interface 100 discussed above with respect to FIG. 1, at least in some environments. After a product specification for an animal feed product has been defined via the graphical user interface 804, a production instruction set 805A is written to an R & D data store 806. The production instruction set (represented as production instruction set 805B) is then transferred, to a production data store 808. A production system, represented by a factory 810, then reads the production instruction set, represented as a production instruction set 805C in order to manufacture the animal feed product 812. In some embodiments, the production instruction set includes human readable instructions that describe to a user how to produce an animal feed product conforming to the product specification.

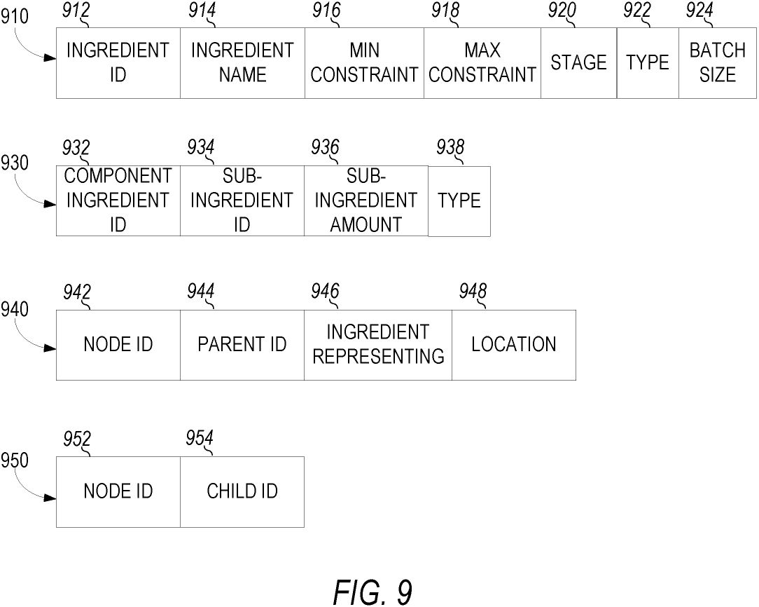

FIG. 9 shows example data structures implemented in one or more of the disclosed embodiments. When the data structures discussed with respect to FIG. 9 are described as relational database tables, one of skill would understand that these are simply examples and a variety of contemplated embodiments utilize a variety of different data structures. For example, various embodiments may utilize non-structured databases, or traditional in-memory structures such as linked lists, arrays, or other structures.

FIG. 9 shows an ingredient table 910, a product specification table 930, a node table 940, a children table 950. Each row of the ingredient table 910 stores information relating to a particular ingredient. An ingredient identified in the ingredient table 910 does not include any other ingredients. The ingredient table 910 includes a plurality of data items or fields including an ingredient identifier field 912, ingredient name field 914, minimum constraint field 916, maximum constraint field 918, stage field 920, a type field 922, and a batch size field 924. The ingredient identifier field 912 uniquely identifies a particular ingredient. The ingredient name field 914 stores a friendly name of the ingredient that is displayed on a computer user interface, at least in some embodiments. The minimum constraint field 916 stores a minimum constraint on use of the ingredient in a single product specification that includes the ingredient. The maximum constraint field 918 stores a maximum limit or constraint on use of the ingredient in a single product specification. The stage field 920 stores a stage for the ingredient (identified via ingredient identifier field 912). A value stored in the stage field 920 determines a graphical indicator of a stage on a computer user interface, as discussed above for example, with respect to stage indicator 122, as implemented in some embodiments. The stage field 920 represents, in some embodiments, a portion of a product process for an animal feed product in which the identified ingredient is employed. The type field 922 stores a value indicating a type of the ingredient (identified via ingredient identifier field 912). The batch size field 924 stores a minimum batch size of the identified ingredient.

The product specification table 930 defines a plurality of data items that indicate a list of ingredients included in a product specification. The product specification table 930 includes an ingredient identifier field 932, sub-ingredient identifier field 934, a sub-ingredient amount field 936, and a type field 938. The ingredient identifier field 932 uniquely identifies an ingredient, and is cross referenceable with at least the ingredient identifier field 912. The ingredient identifier field 932 identifies an ingredient that is a product specification. In other words, the ingredient identified by the ingredient identifier field 932 represents a combination of ingredients included in a product specification. Thus, if a product specification is for cat food, the ingredient identified by ingredient identifier 932 identifies the cat food ingredient. The sub-ingredient identifier field 934 includes an ingredient that is included in the product specification. The sub-ingredient amount field 936 identifies an amount of the sub-ingredient included in the product specification. Note that the product specification table 930 can include multiple rows for a single product specification, each row describing a single ingredient included in the product specification. The type field 938 indicates a type of the component ingredient. For example, in some embodiments, the type field 938 indicates whether the component ingredient is a master product specification, a fixed formula, or another type of component ingredient.

The product specification table 930, in some example embodiments, represents that the “canned cat food” ingredient represented by the root node 106 in FIG. 1 includes sub-ingredients “canned cat food with chicken” (represented by the node 108) and “beef and liver product” (represented by the node 110) via two rows in the product specification table 930. Both rows identify the canned cat food ingredient via field 932, and each row identifies either the “canned cat food with chicken” ingredient or the “beef and liver” product ingredient via field 934. Thus, for example, when an ingredient is dropped on a node of a hierarchy, an additional row is added, in some embodiments, to the product specification table indicating that the dropped ingredient is included in the product specification represented by the node.

The node table 940 includes a node identifier field 942, a parent identifier field 944, an ingredient represented field 946, and a location field 948. The node identifier field 942 uniquely identifies a node, such as any of the root node 106, or the node 108, node 110, or node 112 of FIG. 1. The parent identifier field 944 identifies a parent node of the node identified by the node identifier field 942. The ingredient represented field 946 identifies an ingredient represented by the node identified via field 942. The location field 948 identifies a location within a graphical user interface that the node (identified via 942) is to be displayed. In example embodiments, the node table 940 represents that root node 106 is a parent of node 110 of FIG. 1 by identifying the node 110 via field 942 and identifying the root node 106 via field 944.

The children table 950 includes a node identifier field 952 and a child identifier field 954. The node identifier field 952 uniquely identifies a node in a hierarchy, such as any of the root node 106, or the nodes 108, 110, or 112, discussed above with respect to FIG. 1. The child identifier 954 identifies children of the node (identified via field 952). In the example implementation described by FIG. 9, the children table could include multiple rows for a single node if that single node has multiple children. The children table 950 represents, in an example embodiment, that the node 110 is a child of the root node 106 in FIG. 1. This is represented by field 952 identifying the root node 106 and field 954 identifying the node 110. A second row of the children table 950 identifies the root node 106 via field 952 and the node 108 via the field 954.

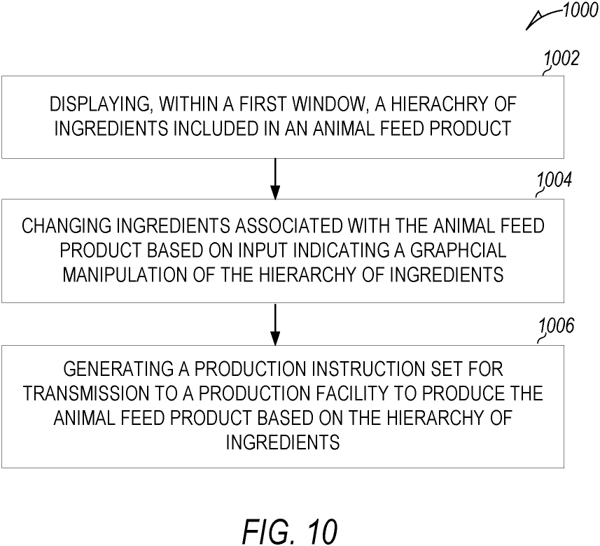

FIG. 10 is a flowchart of a process 1000 for graphically editing an animal feed product. In some embodiments, one or more of the functions discussed below with respect to FIG. 10 are performed by hardware processing circuitry. For example, in some embodiments, a hardware processor (e.g. processor 1202 discussed below) is configured by instructions (e.g. instructions 1224 also discussed below) stored in a memory (e.g. 1204 and/or 1206 discussed below) to perform one or more of the functions discussed below with respect to FIG. 10.

In operation 1002, a hierarchy of ingredients included in an animal feed product is displayed. For example, as discussed above with respect to FIG. 1, the hierarchy 101 displays structure of ingredients included in an animal feed product. Note that the hierarchy 301 illustrated in FIG. 3 is also a hierarchy of ingredients. The hierarchy 301 of FIG. 3 shows a single node representing a single ingredient. However, that single ingredient represents multiple ingredients, whose structure is defined by the single ingredient. As discussed above, the displayed hierarchy includes, in some embodiments, at least one parent node. As shown with respect to FIG. 3 above and hierarchy 301, the hierarchy 301 includes a single parent node representing a “canned cat food” ingredient. Some hierarchies also include at least one child node of the single parent node. For example, as illustrated above with respect to FIG. 1, the parent and root node 106 also has two child nodes, the node 108 and the node 110. The parent and root node 106 and child nodes, node 108 and node 110 are connected via line(s) 113A and 113B.

As discussed above with respect to FIG. 1, one or more of the nodes displayed in the graphical user interface include indicator(s) for a stage of production of the ingredient (e.g. 120 and/or 122) and an indicator of a type of ingredient (e.g. type indicator 116).

In operation 1004, ingredients associated with the animal feed product are changed. The change is based on input indicating a graphical manipulation of the hierarchy of ingredients. The graphical manipulation can include any one or more of deleting a node in the hierarchy (causing a corresponding deletion of an ingredient represented by the deleted node from the animal feed product), moving a node in the hierarchy from a first location in the hierarchy having a first parent node to a second location in the hierarchy having a second parent node (causing a corresponding deletion of the ingredient from an ingredient represented by the first parent and an addition of the moved ingredient to the ingredient represented by the second parent node), or an addition to a parent node of the hierarchy (causing an addition of the ingredient to a parent ingredient represented by the parent node). The addition is performed, in some embodiments, by dropping a graphical indicator of the added ingredient onto the parent node. For example, as discussed above with respect to FIG. 1, a graphical indicator of any one of the ingredients represented by any one or more of the node 108 or node 110 is dropped on the ingredient represented by root node 106 to establish a parent/child relationship between the dropped ingredient (e.g. beef and liver product) and the parent ingredient (e.g. canned cat food). Similarly, a graphical indicator of an ingredient represented by node 112 (e.g. “Gravy...”) is dropped on node 110 to form a second layer in the hierarchy, which establishes a parent/child relationship between node 110 and node 112. When an ingredient is added to the animal feed product, amount information for the ingredient is also updated, in at least some embodiments. For example, as discussed above with respect to FIG. 9, some embodiments store sub-ingredient amount information in the field 936. Some embodiments add a default amount of ingredient upon adding an ingredient to a product specification via the graphical user interface. In some embodiments, the default amount is specific to each ingredient or ingredient type. Some embodiments include updating amount information based in input from a user interface. For example, in some embodiments, upon graphically adding an ingredient to a product specification, a prompt is displayed requesting entry of an amount of the added ingredient. A default amount is included in the prompt in some embodiments.

As discussed above with respect to FIGS. 4-5, some embodiments include detecting when multiple instances of a single ingredient are included in a hierarchy. If a new ingredient is added to a single one of these multiple instances, for example, via a graphical input, some embodiments then add the new ingredient to each of the multiple instances of the single ingredient. Thus, if, for example, an instance of the single ingredient is included in each of three other component ingredients, each of those component ingredients will include the new ingredient after the graphical input.

In operation 1006, a production instruction set is generated. As discussed for example with respect to FIG. 8, the production instruction set 805A is generated by an application displaying the graphical user interface 804 and stored in the R&D data store 806. The production instruction set is then transmitted (e.g. represented by production instruction set 805B) to a production facility, which includes, in the embodiment illustrated by FIG. 8, the production data store 808. The production instruction set defines ingredients used in an animal feed product. The production instruction set also defines a production order in which the ingredients are combined, and an amount of each ingredient used. The product instruction set also defines any ingredients that are aggregated into component ingredients. For example, a component ingredient represented by root node 106 includes at least two sub-ingredients, a first sub-ingredient represented by the node 108 and a second sub-ingredient represented by the node 110. Each of the sub-ingredients with respect to root node 106 may themselves also be component ingredients that include multiple sub-ingredients. The production instruction set defines a production process that allows the production facility to manufacture an animal feed product consistent with a state of a hierarchy at the time the product instruction set was generated or stored.

Some embodiments of process 1000 trigger an analysis of the product specification, and display an indicium of feasibility of production based on the analysis. In various embodiments, the feasibility analysis compares a total amount of ingredients required by the product specification to previous production amounts of those ingredients. Some embodiments also compare minimum and/or maximum constraints of each ingredient included in the product specification (e.g. stored, in some embodiments, in fields 916 and/or 918) to a total amount of the ingredient included in the product specification. If the total amount is below the minimum constraint or above the maximum constraint, the feasibility analysis indicates the product specification is not feasible. Otherwise, in the absence of any other conditions indicating infeasibility, the feasibility analysis indicates the product specification is feasible. Some embodiments then output a message or other indicium of feasibility based on the analysis.

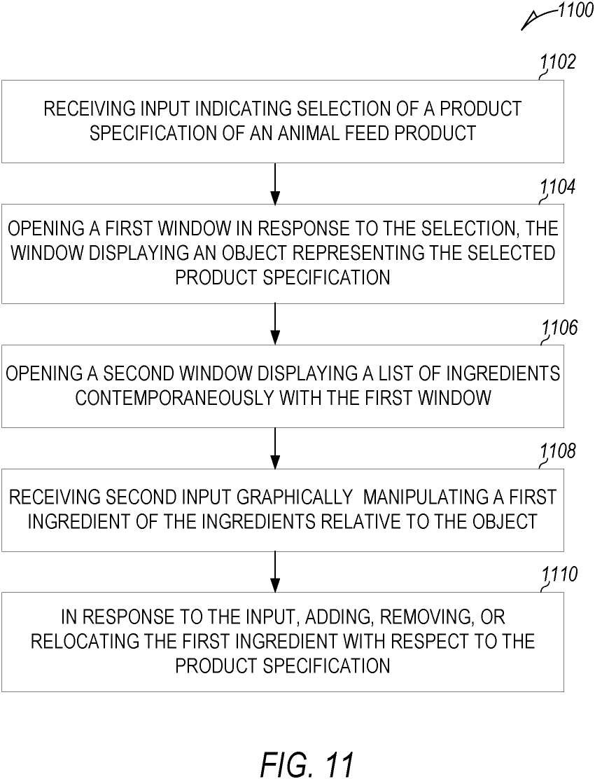

FIG. 11 is a flowchart of a process 1100 for graphically editing a product specification for an animal feed product. In some embodiments, one or more of the functions discussed below with respect to FIG. 11 are performed by hardware processing circuitry. For example, in some embodiments, a hardware processor (e.g. processor 1202 discussed below) is configured by instructions (e.g. instructions 1224 also discussed below) stored in a memory (e.g. 1204 and/or 1206 discussed below) to perform one or more of the functions discussed below with respect to FIG. 11.

In operation 1102, input is received indicating selection of a product specification of an animal feed product. As discussed above with respect to FIG. 2, in some embodiments, a product specification is selected from a list of ingredients. In FIG. 2, the product specification for “canned cat food” is selected via menu window 214 and second menu window 218. Via the second menu window 218, the “product designer” is selected. This is just one example of how a product specification is selected in operation 1102.

In operation 1104, a first window is opened in response to the selection. The window displays a first object (e.g. node) representing the selected product specification. For example, as discussed above with respect to FIG. 3, selection of the “product designer” menu item in concert with the selected product specification causes, in some embodiments, opening of the graphical editing window 304. The graphical editing window 304 displays the first object (e.g. root node 106), which represents the selected product specification (ingredient). The first object is the first node of a hierarchy representing contents of the product specification (analogous to the hierarchy 101 discussed above with respect to FIG. 1 and/or the hierarchy 301 discussed above with respect to FIG. 3).

In operation 1106, a second window is opened. The second window displays a list of ingredients contemporaneously with the first window. In some embodiments, the second window is analogous to the first window 102, discussed above with respect to FIG. 1, and/or the first window 302, discussed above with respect to FIG. 3. In some embodiments, the second window is adjacent to the first window. The list of ingredients included in the second window can include one or more of at least product specifications, component ingredients, ingredients, or fixed formulas, all of which are broadly included as “ingredients” in the list of ingredients.

In operation 1108, second input is received indicating a graphical manipulation of a first ingredient in the list of ingredients relative to the displayed first object. For example, in some embodiments, the graphical manipulation includes dragging an ingredient from the list of ingredients and dropping the ingredient on the first object displayed in the first window. In some embodiments, graphical manipulation can include selecting an ingredient in the list of ingredients, and then using copy/paste to paste the selected ingredient onto the displayed first object.

Operation 1108 may alternatively include a graphical manipulation that includes selection of the displayed first object included in the hierarchy, and an additional input indicating a deletion operation of the selected object (e.g. the delete key on a keyboard, or selection of a delete menu item).

In operation 1110, the first ingredient is added, removed, or relocated in response to the received second input. In an example embodiment, in response to a dropping of the first ingredient onto the displayed first object, which represents a second ingredient, the first ingredient is added to a list of ingredients included in the second ingredient. Thus, the second ingredient becomes a component ingredient as a result of this operation (if it was not a component ingredient previously). In response to the dropping or other additional input, a new object is generated and displayed in the first window. The new second object is established as a child of the displayed first object. A graphical indicium of connectedness (e.g. a line) is established between the first object and the second object. In some embodiments, the parent/child relationship between first object and second object is established via data structures such as the examples discussed above with respect to FIG. 9. For example, a new entry/row in the node table 940 is generated when the new second object is created. The new entry stores a parent identifier of the new object (e.g. the first object), information indicating the ingredient represented by the new second node (e.g. the first ingredient selected from the second window discussed above), and a location of the node within the first window (e.g. below the first object). An additional entry is also added, in some embodiments, to the children table 950, indicating the first object (e.g. indicated by field 952) has a child (e.g. indicated by field 954 as the new second object).

Some embodiments of process 1100 include saving a first product specification represented by the hierarchy as a production instruction set. For example, as discussed above with respect to FIG. 8, some embodiments store a production instruction set, and send the production instruction set to a production facility. At the production facility, the production instruction set is utilized to control an animal feed manufacturing process so as to be consistent with the combination, amounts and a production order of ingredients indicated by the production instruction set and hierarchy. The production instruction set defines ingredients, amounts of ingredients, how the ingredients are combined, and a production sequence of the ingredients. This information is derived from the hierarchy and the corresponding data tables. For example, the production sequence is defined by traversing the hierarchy from the bottom to the top. First ingredients listed below second ingredients in the hierarchy are produced before the second ingredients. The amount of each ingredient is provided, in some embodiments, by data tables associated with the hierarchy.

In some embodiments, the product specification is saved as an ingredient. For example, in some embodiments, a product specification consistent with the hierarchy is saved as an ingredient in the ingredient palette or list of ingredients displayed in the first window 102, discussed above with respect to FIG. 1, and/or the ingredient palette shown in the first window 302 of FIG. 3. The first product specification can then be added to a second product specification in a similar manner as ingredients are added to the first product specification as described above. For example, a graphical input selects the first product specification, in some embodiments, from the ingredient palette. The first product specification is then added to the second product specification by dropping the first product specification onto a node of a hierarchy representing the second product specification

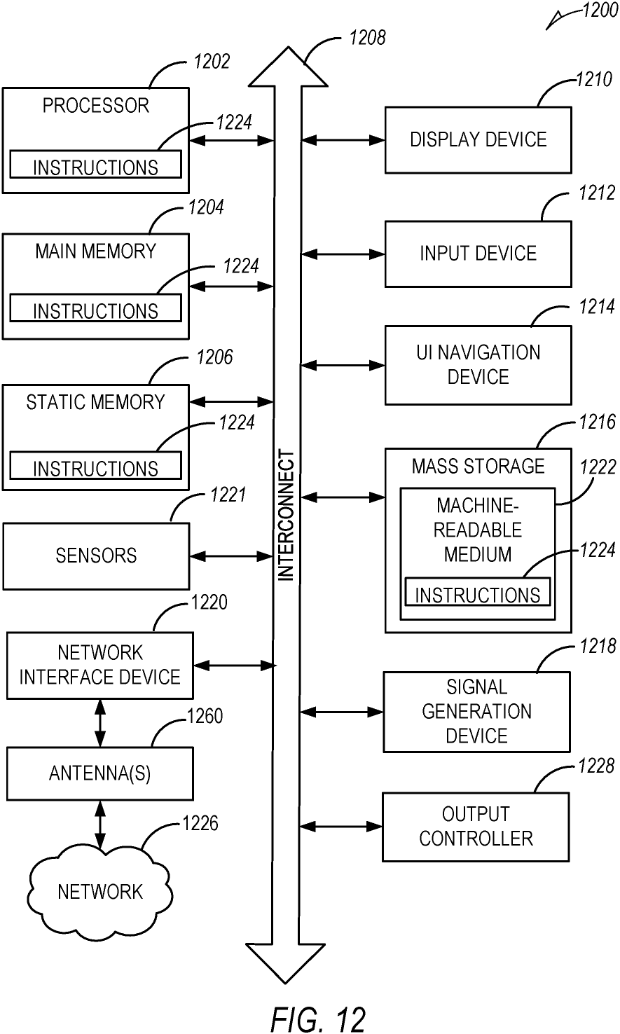

FIG. 12 illustrates a block diagram of an example machine 1200 upon which any one or more of the techniques (e.g., methodologies) discussed herein may perform. In alternative embodiments, the machine 1200 may operate as a standalone device or may be connected (e.g., networked) to other machines. In a networked deployment, the machine 1200 may operate in the capacity of a server machine, a client machine, or both in server-client network environments. In an example, the machine 1200 may act as a peer machine in peer-to-peer (P2P) (or other distributed) network environment. The machine 1200 may be a personal computer (PC), a tablet PC, a set-top box (STB), a personal digital assistant (PDA), a mobile telephone, a smart phone, a web appliance, a network router, switch or bridge, a server computer, a database, conference room equipment, or any machine capable of executing instructions (sequential or otherwise) that specify actions to be taken by that machine. In various embodiments, machine 1200 may perform one or more of the processes described above with respect to FIGS. 1-11 above. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (all referred to hereinafter as “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1200 may include a hardware processor 1202 (e.g., a central processing unit (CPU), a graphics processing unit (GPU), a hardware processor core, or any combination thereof), a main memory 1204 and a static memory 1206, some or all of which may communicate with each other via an interlink 1208 (e.g., bus). The machine 1200 may further include a display unit 1210, an alphanumeric input device 1212 (e.g., a keyboard), and a user interface (UI) navigation device 1214 (e.g., a mouse). In an example, the display unit 1210, input device 1212 and UI navigation device 1214 may be a touch screen display. The machine 1200 may additionally include a storage device (e.g., drive unit) 1216, a signal generation device 1218 (e.g., a speaker), a network interface device 1220, and one or more sensors 1221, such as a global positioning system (GPS) sensor, compass, accelerometer, or another sensor. The machine 1200 may include an output controller 1228, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 1216 may include a machine readable medium 1222 on which is stored one or more sets of data structures or instructions 1224 (e.g., software) embodying or utilized by any one or more of the techniques or functions described herein. The instructions 1224 may also reside, completely or at least partially, within the main memory 1204, within static memory 1206, or within the hardware processor 1202 during execution thereof by the machine 1200. In an example, one or any combination of the hardware processor 1202, the main memory 1204, the static memory 1206, or the storage device 1216 may constitute machine readable media.

While the machine readable medium 1222 is illustrated as a single medium, the term “machine readable medium” may include a single medium or multiple media (e.g., a centralized or distributed database, and/or associated caches and servers) configured to store the one or more instructions 1224.

The term “machine readable medium” may include any medium that is capable of storing, encoding, or carrying instructions for execution by the machine 1200 and that cause the machine 1200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 1224 may further be transmitted or received over a communications network 1226 using a transmission medium via the network interface device 1220. The machine 1200 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1220 may include one or more physical jacks (e.g., Ethernet, coaxial, or phone jacks) or one or more antennas 1260 to connect to the communications network 1226. In an example, the network interface device 1220 may include a plurality of antennas to wirelessly communicate using at least one of single-input multiple-output (SIMO), multiple-input multiple-output (MIMO), or multiple-input single-output (MISO) techniques. In some examples, the network interface device 1220 may wirelessly communicate using Multiple User MIMO techniques.

1. A method of graphical editing of an animal feed product, comprising:
displaying, within a first window of a graphical user interface, a hierarchy of ingredients included in the animal feed product, the hierarchy including a parent node and a child node of the parent node, the child node displayed below the parent node in the first window and graphically connected to the parent node via a line, an ingredient represented by the parent node including a second ingredient represented by the child node, each node visually indicating a type and a stage of production of an ingredient represented by the node;
changing ingredients associated with the animal feed product based on input indicating a graphical manipulation of the hierarchy of ingredients; and
generating a production instruction set for transmission to a production facility to produce the animal feed product based on the hierarchy of ingredients, the production instruction set defining at least in part a production sequence to produce the animal feed product.

2. The method of claim 1, further comprising:
displaying a second window, the second window including a list of ingredients; and
adding an ingredient displayed in the second window to the animal feed product based on input indicating the ingredient was dragged and dropped on a node of the hierarchy.

3. The method of claim 1, wherein the changing of the ingredients associated with the animal feed product comprises detecting a plurality of instances of a first ingredient, each of the instances of the first ingredient included in a different component ingredient, and adding a new ingredient to each instance of the first ingredient in response to a graphical manipulation indicating an addition of the new ingredient to any one instance of the first ingredient.

4. A method for a graphical presentation that facilitates production of an animal feed product, comprising:
receiving input, via a computer user interface, indicating selection of a product specification of the animal feed product;
opening a first window in response to the selection, the window displaying an object representing the selected product specification;
opening a second window displaying a list of ingredients contemporaneously with the first window;
receiving input graphically manipulating a first ingredient of the ingredients relative to the object; and
in response to the input, adding, removing, or relocating the first ingredient with respect to the product specification.

5. The method of claim 4, further comprising indicating, based on the input, a position of the first ingredient in a production order defined by the product specification.

6. The method of claim 4, further comprising updating amount information of the first ingredient in the product specification based on the input.

7. The method of claim 4, further comprising:
storing the product specification; and
adding, based on a graphical input, the product specification as an ingredient to a second product specification.

8. The method of claim 4, further comprising generating a production instruction set for transmission to a production facility based on the product specification.

9. The method of claim 8, further comprising
receiving the production instruction set;
presenting instructions to a user to produce the animal feed product conforming to the product specification.

10. The method of claim 4, wherein the product specification comprises a plurality of data items, one or more of the data items defining an ingredient or component included in the animal feed product.

11. The method of claim 10, wherein each of the data items defines one or more of a location of an ingredient, a stage of the ingredient, a batch size of the ingredient, a minimum constraint of the ingredient, a maximum constraint of the ingredient, or whether the data item represents a master product specification or a fixed formula.

12. The method of claim 11, comprising receiving second input defining a minimum constraint or a maximum constraint corresponding to the first ingredient within the animal feed product.

13. The method of claim 4, comprising:
displaying a second object representing the first ingredient in the graphical user interface in response to the input adding the first ingredient; and
displaying an indicium graphically connecting the first object to the second object in response to the input adding the first ingredient on the product specification.

14. The method of claim 13, further comprising displaying a graphical indicator of a stage of the first ingredient within the object, the stage indicating a portion of a production process for the animal feed product in which the first ingredient is employed.

15. The method of claim 14, further comprising displaying a graphical indicator of a second stage of the product specification within the second object, the second stage indicating a portion of the production process for the animal feed product in which the product specification is employed.

16. The method of claim 4, further comprising receiving a second input dropping a fixed formula on the first object, and displaying a second object representing the fixed formula within the first window in response to the second input.

17. The method of claim 16, comprising displaying an indicator in the second object that the second object represents the fixed formula.

18. The method of claim 17, comprising displaying a second indicator in the first object that the first object represents an ingredient.

19. The method of claim 4, further comprising:
triggering analysis of the product specification; and
displaying an indicium of feasibility of production based on the analysis.

20. The method of claim 4, wherein the animal feed product comprises a pet food product.
